(19) United States
(12) Patent Application Publication
(10) Pub. No.: US 2014/0143314 A1
(43) Pub. Date: May 22, 2014

(54) COMMUNICATION SYSTEM

(71) Applicant: HITACHI, LTD., Tokyo (JP)

(72) Inventor: Shota NAKAMURA, Tokyo (JP)

(73) Assignee: HITACHI, LTD., Tokyo (JP)

(21) Appl. No.: 14/080,331

(22) Filed: Nov. 14, 2013

(30) Foreign Application Priority Data
Nov. 22, 2012 (JP) 2012-255813

(51) Int. Cl. H04L 29/08

(52) U.S. Cl. CPC H04L 67/104
USPC 709/203

(57) ABSTRACT

In a 3PCC procedure disclosed herein, before a call is initiated between a first peer terminal and a second peer terminal, the second peer terminal decides whether to make a connection to the source (caller) peer terminal. The 3PCC procedure includes a step of deciding whether or not to initiate a 3PCC service based on the decision made by the second peer terminal before establishing a session between the first and second peer terminals.

### INCORPORATION BY REFERENCE

The present application claims priority from Japanese application JP2012-255813 filed on Nov. 22, 2012, the content of which is hereby incorporated by reference into this application.

### BACKGROUND

The present invention relates to a communication system and a server and, in particular, to a communication system and a server regarding a point-to-point (peer-to-peer) connection method in a next generation network.

Recently, study on a next generation communication network taking advantage of IP (Internet Protocol) technology is actively conducted by telecommunication carriers. This kind of next generation communication network is called an NGN (Next Generation Network). In the NGN, such a method is often adopted that establishes a session between a server and a client to communicate with each other and makes bandwidth management on the session-by-session basis. In the NGN, as a session control protocol that is used for bandwidth allocation, for example, a SIP (Session Initiation Protocol) is used.

A technique is disclosed in which, when a client device that is not equipped with a control protocol of a session for bandwidth allocation is initiating communication in a bandwidth guaranteed network, a session proxy device establishes a session for bandwidth allocation in the bandwidth guaranteed network on behalf of the client device (for example, Japanese Unexamined Patent Application Publication No. 2008-78878).

SOAP (Simple Object Access Protocol) for information exchange between applications is also known.

A technique for data transmission between two parties that are allowed to communicate with each other in a Quality of Service guaranteed NGN is disclosed (for example, Japanese Unexamined Patent Application Publication No. 2010-213027).

### SUMMARY

In the NGN, it is mandatory that IP addresses for establishing a signaling channel and a data channel are the same. This poses a problem in which it becomes impossible that a proxy establishes a data channel between two parties (a first peer terminal and a second peer terminal) that are allowed to communicate with each other as in a 3PCC (3rd Party Call Control) service flow which has heretofore been used. In the 3PCC service flow, a device that implements 3PCC first establishes a session between it and a first peer terminal and then establishes a session between it and a second peer terminal. When a call is set up between the first peer terminal and the second peer terminal, the establishment of the session with the first peer terminal is completed and the establishment of the session with the second peer terminal is initiated.

In the 3PCC service, because a third party other than two parties (the first and second peer terminals) that are to communicate with each other originates a call to the two parities respectively, source information (a telephone number) that is notified to the first or second peer terminal is that information of the third party, not that information of the source peer terminal (caller). Another problem is as follows: if the first peer terminal makes a call, whereas a called parity (second peer terminal) cannot answer the call, although the call connection between the first and second peer terminals is not established, a session between the first peer terminal and the third party is established, so the caller (first peer terminal) is charged for the established session when charging is performed at the same time.

A communication system according to the present invention, as an example, includes a Web server and a control apparatus that communicates with a first terminal and a second terminal. The control apparatus includes an interface that receives from the Web server a connection request message including “To URI” corresponding to the first terminal and “From URI” corresponding to the second terminal; and a first controller that sends a first message including the “To URI”, the “From URI”, and a session ID to the first terminal in accordance with the received connection request message, performs control so that a call connection success message is sent to the Web server, if the control apparatus receives from the first terminal a second message including the session ID and information indicating answer accept in response to the first message, and sets up a session with the first terminal based on the session ID as well as a session with the second terminal based on the session ID.

According to the present invention, in a 3PCC service, before a call is initiated between a first peer terminal and a second peer terminal, the second peer terminal can identify the source (caller) peer terminal. Also, it can be decided whether the called party initiates or cancels a 3PCC service before a session is established between the first and second peer terminals. Via a user setting screen, if provided as appropriate, it is also possible to allow the user of the second peer terminal to select a terminal to receive the call depending on the situation.

### BRIEF DESCRIPTION OF THE DRAWINGS

FIG. 1 is an explanatory diagram depicting an architecture example of a communication network;

FIG. 2 is an explanatory diagram depicting a configuration example of a SOAP-SIP adapter;

FIG. 3-1 is an explanatory diagram representing an example of structure of a session information table in the SOAP-SIP adapter;

FIG. 3-2 is an explanatory diagram representing an example of structure of a call participants information table in the SOAP-SIP adapter;

FIG. 3-3 is an explanatory diagram representing an example of structure of a terminal information table in the SOAP-SIP adapter;

FIG. 3-4 is an explanatory diagram representing an example of structure of a media stream control information table in the SOAP-SIP adapter;

FIG. 3-5 is an explanatory diagram representing an example of structure of a second peer terminal answer status information table 2050 in the SOAP-SIP adapter;

FIG. 4-1 is a structural diagram representing an example of structure of a 3PCC service request answer information table in a terminal;

FIG. 4-2 is a structural diagram representing an example of structure of an answer phone list table in the terminal;

FIG. 5 is a diagram depicting a configuration example of the terminal;

FIG. 6 depicts an example of a screen which is displayed upon receiving an answer request;

FIG. 7 is a flowchart to explain generating a session ID/connection ID in the SOAP-SIP adapter;

FIG. 8 is a flowchart to explain an operation of the SOAP-SIP adapter upon receiving a call initiation request;

FIG. 9 is a flowchart to explain an operation of the SOAP-SIP adapter upon receiving a call information (session information) request;

FIG. 10 is a flowchart to explain an operation of the SOAP-SIP adapter upon receiving a call participants information request;

FIG. 11 is a flowchart to explain an operation of the SOAP-SIP adapter upon receiving a call termination request;

FIG. 12 is a sequence diagram (1) to explain a 3PCC service procedure;

FIG. 13 is a sequence diagram (2) to explain a 3PCC service procedure;

FIG. 14 is a sequence diagram (3) to explain a 3PCC service procedure;

FIG. 15 is a sequence diagram (4) to explain a 3PCC service procedure;

FIG. 16 is a configuration diagram of a Web server; and

FIG. 17 is a flowchart to explain an operation of the terminal when receiving a SIP MESSAGE and sending a SIP MESSAGE.

### DETAILED DESCRIPTION

### 1. First Embodiment

### Network Architecture

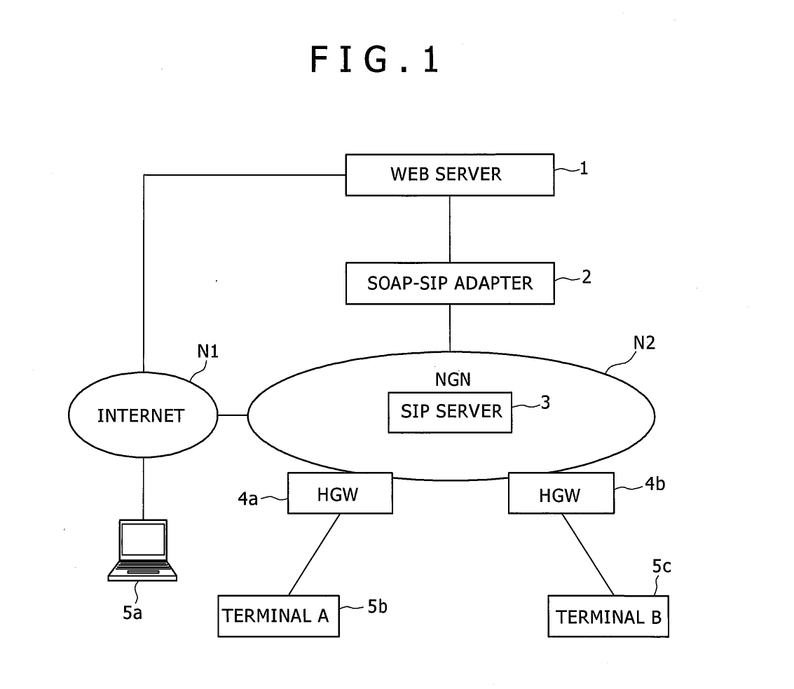

FIG. 1 is an explanatory diagram depicting an architecture example of a communication network according to a first embodiment.

This communication network (system) includes, e.g., a Web server 1, a SOAP-SIP adapter 2, a SIP server 3, and HGWs (Home Gateways) 4a and 4b. The SIP server 3 is situated in, e.g., an NGN N2.

The Web server 1 communicates with the SOAP-SIP adapter 2. The Web server 1 also communicates with a terminal 5a via a network such as Internet N1. The SOAP-SIP adapter 2 communicates with a terminal A5b via the NGN N2 and a HGW 4a. The SOAP-SIP adapter 2 also communicates with a terminal B5c in the same way.

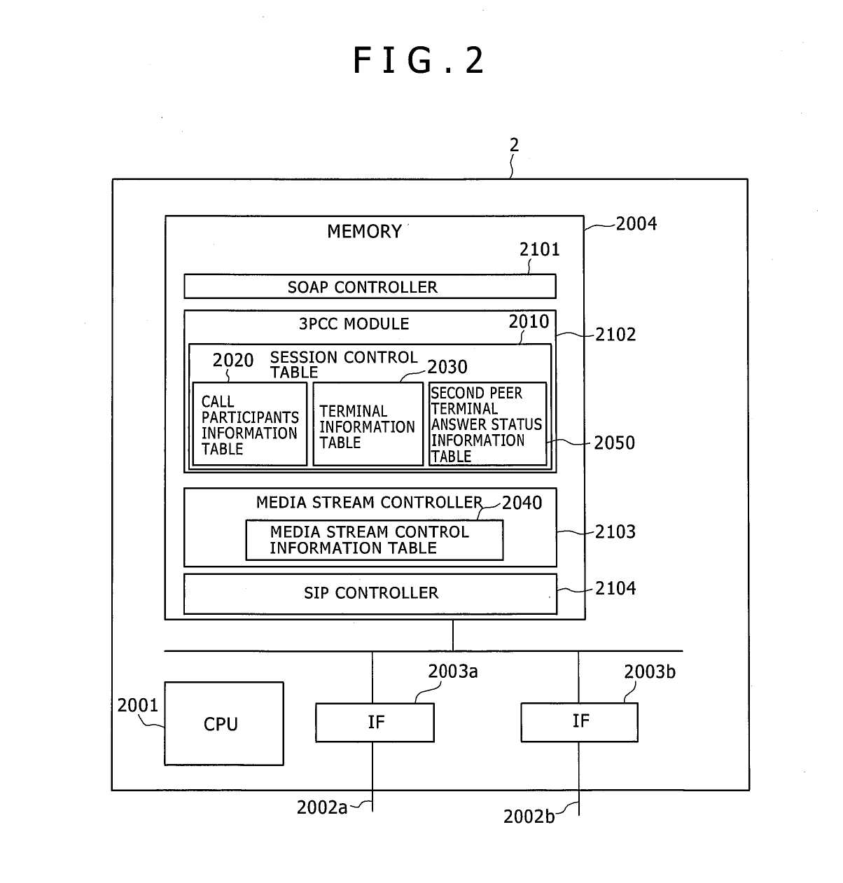

FIG. 2 is an explanatory diagram depicting a configuration example of the SOAP-SIP adapter 2 according to the first embodiment.

The SOAP-SIP adapter 2 includes, e.g., a processor (hereinafter referred to as CPU) 2001, interfaces (hereinafter abbreviated to IFs) 2003a and 2003b, and a memory 2004. The SOAP-SIP adapter 2 may be installed as a control apparatus or a control server. The memory 2004 has a SOAP controller 2101, a 3PCC module 2102, a media stream controller 2103, and a SIP controller 2104. The 3PCC module 2102 has a session information table 2010 and the media stream controller 2103 has a media stream control information table 2040. The session information table 2010 has a call participants information table 2020, a terminal information table 2030, and a second peer terminal answer status information table 2050.

The CPU 2001 executes all processes in the SOAP-SIP adapter 2. The SOAP controller 2101, 3PCC module 2102, media stream controller 2103, and SIP controller 2104 provided in the memory 2004 are executed by the CPU 2001. The IFs 2003 are interfaces for communication with the Web server 1 and the NGN N2 via links 2002.

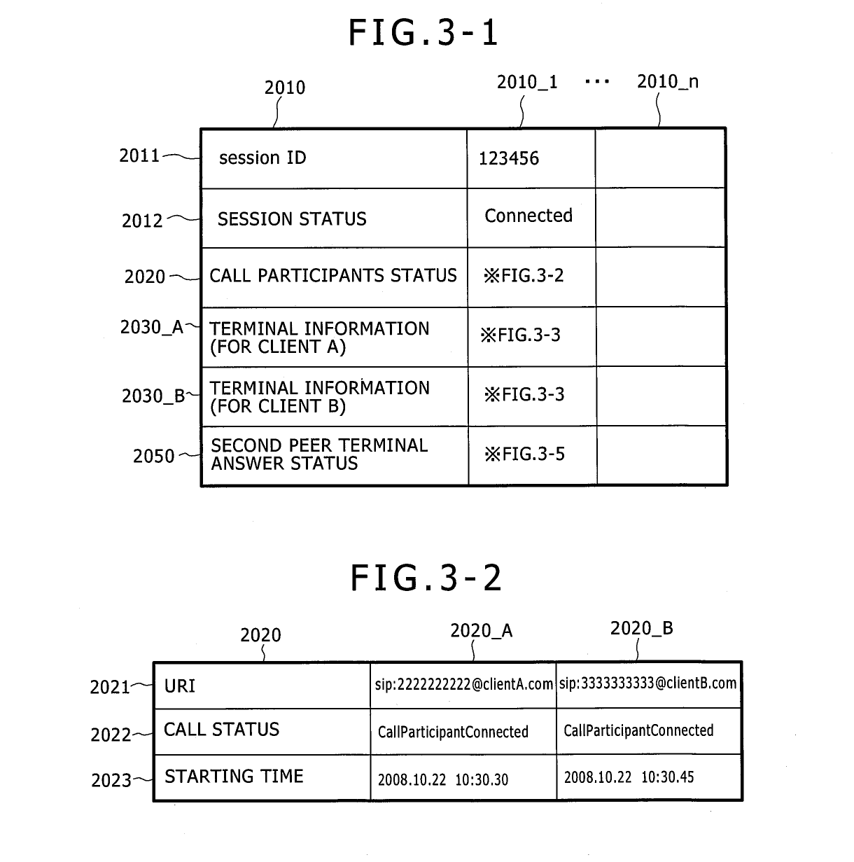

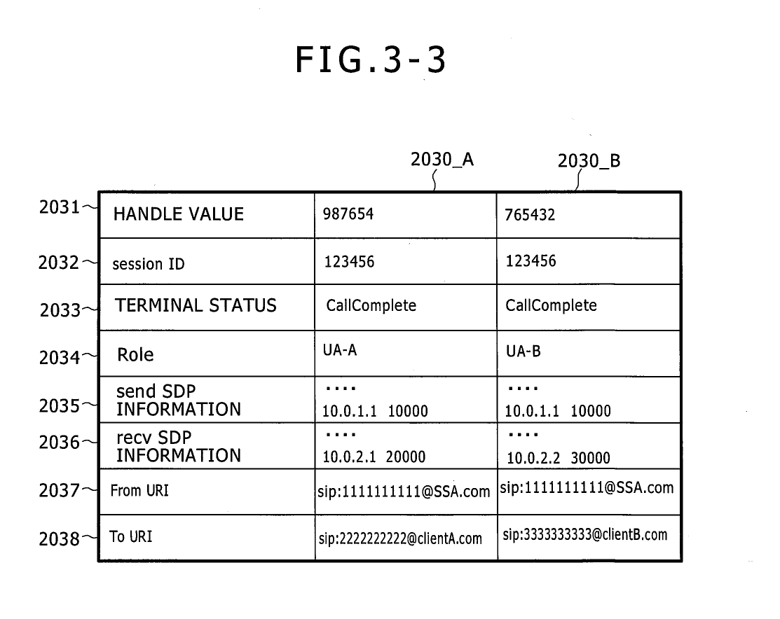

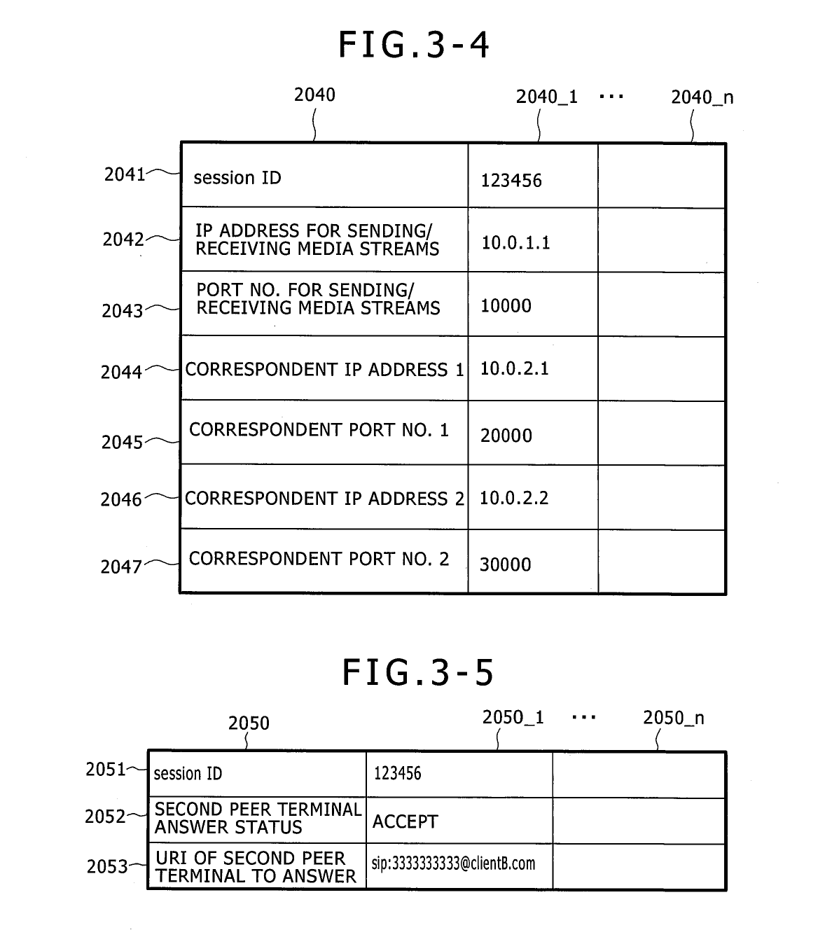

FIG. 3-1 is an explanatory diagram representing an example of structure of the session information table 2010 in the SOAP-SIP adapter 2 according to the first embodiment.

The session information table 2010 stores, for each session ID 2011, e.g., session status 2012, call participants status 2020, terminal information 2030, and second peer terminal answer status 2050.

The session ID 2011 is the identifier of a session for which a connection request is sent from the Web server 1. The session ID 2011 identifies a session for communication between the terminals A5b and B5c. The session status 2012 indicates the status of a session designated by the session ID 2011. In the session status 2012 record, e.g., status such as “Initial”, “Connected”, or “Terminated” is stored. The call participants status 2020 record is equivalent to the call participants information table 2020. Detail on the call participants information table 2020 will be described later. The terminal information 2030 record is equivalent to the terminal information table 2030. The terminal information 2030 for each terminal is stored individually. In an example presented here, terminal information (for Client A) 2030_A associated with the terminal A5b and terminal information (for Client B) 2030_B associated with the terminal B5c are stored. Detail on the terminal information table 2030 will be described later. The second peer terminal answer status 2050 record is equivalent to the second peer terminal answer status information table 2050. Detail on the second peer terminal answer status information table 2050 will be described later.

FIG. 3-2 is an explanatory diagram representing an example of structure of the call participants information table 2020 in the SOAP-SIP adapter 2 according to the first embodiment.

The call participants information table 2020 stores, e.g., URI 2021, call status 2022, and starting time (instant) 2023 with respect to each terminal.

The URI 2021 indicates SIP-URI relevant to each user. The call status 2022 indicates status of a SIP session between the SOAP-SIP adapter 2 and each terminal 5b, 5c. In this record, e.g., status such as “CallParticipantInitial”, “CallParticipantConnected”, or “CallParticipantTerminated” is stored. The starting time 2023 indicates a time instant when the SOAP-SIP adapter 2 has established a SIP session with each terminal 5b, 5c.

FIG. 3-3 is an explanatory diagram representing an example of structure of the terminal information table 2030 in the SOAP-SIP adapter 2 according to the first embodiment.

In the terminal information table 2030, e.g., parameters or the like that are used in SIP are stored. The terminal information table 2030 stores, e.g., a handle value 2031, session ID 2032, terminal status 2033, Role 2034, send SDP (Session Description Protocol) information 2035, recv SDP information 2036, From URI 2037, and To URI 2038.

The handle value 2031 is information that identifies a SIP session between the SOAP-SIP adapter 2 and the terminal 5b and a SIP session between the SOAP-SIP adapter 2 and the terminal B5c respectively. The session ID 2032 corresponds to the foregoing session ID 2011 in the session information table 2010. The terminal status 2033 indicates status up to and at the establishment of a session between the SOAP-SIP adapter 2 and each terminal 5b, 5c. In the terminal status 2033 record, e.g., status such as “Initial”, “ConnectWait” (awaiting a “response”), “CallComplete” (having received a “response” and established a session with UA), “CloseWait” (awaiting a “notification of disconnection completed”), or “Closed” (termination) is stored. Note that status “Initial” or “ConnectWait” corresponds to call status 2022 “CallParticipantInitial” that is stored in the call participants information table 2020. Status “CallComplete” or “CloseWait” corresponds to call status 2022 “CallParticipantConnected” that is stored in the call participants information table 2020. Status “CloseWait” corresponds to call status 2022 “CallParticipantTerminated”.

The Role 2034 is information that indicates a calling party or called party. The send SDP information 2035 includes, e.g., the IP address and port number of the SOAP-SIP adapter 2. The recv SDP information 2036 includes, e.g., the IP address and port number of the terminal A5b or the terminal B5c. The From URI 2037 indicates the source URI of a SIP message that SOAP-SIP adapter 2 sends. The From URI 2037 is, e.g., the SIP-URI of the SOAP-SIP adapter 2. The To URI 2038 indicates the destination URI of a SIP message that the SOAP-SIP adapter 2 sends. The To URI 2038 is, e.g., the SIP-URI of the terminal A5b or the terminal B5c.

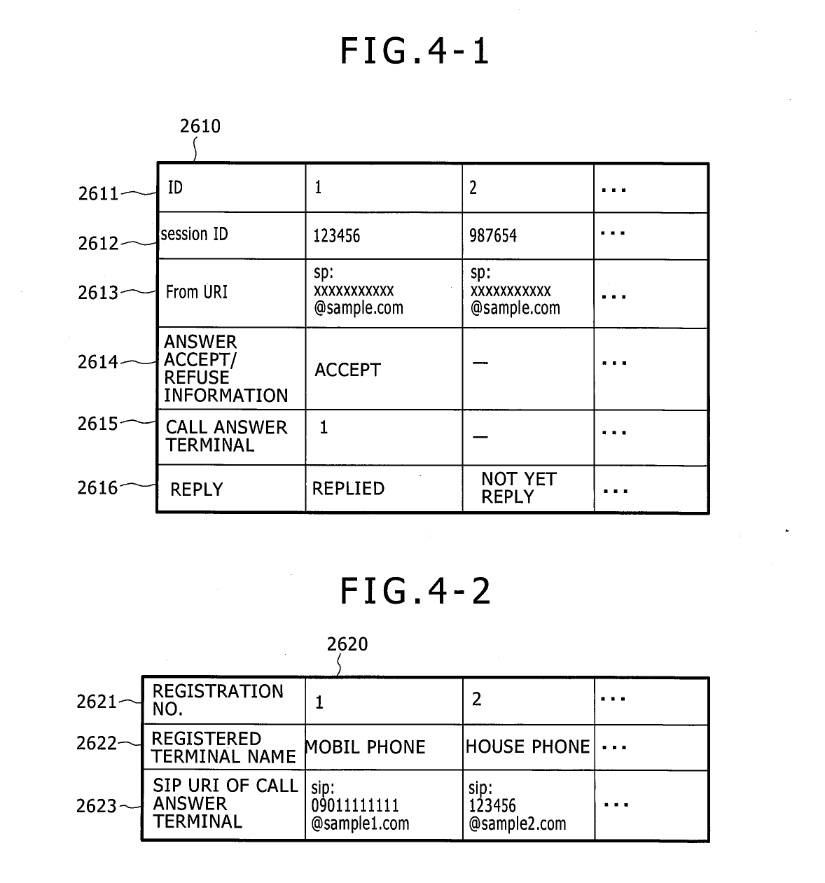

FIG. 3-4 is an explanatory diagram representing an example of structure of the media stream control information table 2040 in the SOAP-SIP adapter 2 according to the first embodiment.

The media stream control information table 2040 stores, for each session ID 2041, e.g., IP address for sending/receiving media streams 2042, port No. for sending/receiving media streams 2043, correspondent IP address (1) 2044, correspondent port No. (1) 2045, correspondent IP address (2) 2046, and correspondent port No. (2) 2047.

The session ID 2041 corresponds to the session ID 2011 in the session information table 2010. The IP address for sending/receiving media streams 2042 and the port No. for sending/receiving media streams 2043 are the IP address and port No. of an IF 2003 that the SOAP-SIP adapter 2 uses for forwarding media streams. A pair of the correspondent IP address (1) 2044/correspondent port No. (1) 2045 and the correspondent IP address (2) 2046/correspondent port No. (2) 2047 indicates a destination to which media streams are forwarded. For example, if the source that transmits media streams is the correspondent IP address (1) 2044/correspondent port No. (1) 2045, the SOAP-SIP adapter 2 forwards the media streams to the destination that is the correspondent IP address (2) 2046/correspondent port No. (2) 2047. Likewise, if the source that transmits media streams is the correspondent IP address (2) 2046/correspondent port No. (2) 2047, the SOAP-SIP adapter 2 forwards the media streams to the destination that is the correspondent IP address (1) 2044/correspondent port No. (1) 2045. In an example presented here, the correspondent IP address (1) 2044/correspondent port No. (1) 2045 indicates the IP address/port No. of the terminal A5b and the correspondent IP address (2) 2046/correspondent port No. (2) 2047 indicates the IP address/port No. of the terminal B5c.

FIG. 3-5 is an explanatory diagram representing an example of structure of the second peer terminal answer status information table 2050 in the SOAP-SIP adapter 2 according to the first embodiment.

The second peer terminal answer status information table 2050 stores information on the destination of a call connection that is requested by makeCallSessionRequest that is sent from the Web server. This table stores, e.g., session ID 2051, second peer terminal answer status 2052 which is information as to whether a destination terminal to which a call is connected makes an answer, and URI of second peer terminal to answer 2053 which is identification information of the destination terminal to which a call is connected.

The session ID 2051 corresponds to the foregoing session ID 2011 in the session information table 2010. The second peer terminal answer status 2052 indicates status information as to whether the terminal 5c can answer the arrived call, which is obtained by, e.g., sending/receiving SIP messages between the SOAP-SIP adapter 2 and the terminal 5c. In the second peer terminal answer status 2052 record, e.g., status such as “Waiting” (awaiting answer), “Accept” (accept the call), or “Refuse” (refuse to answer the call).

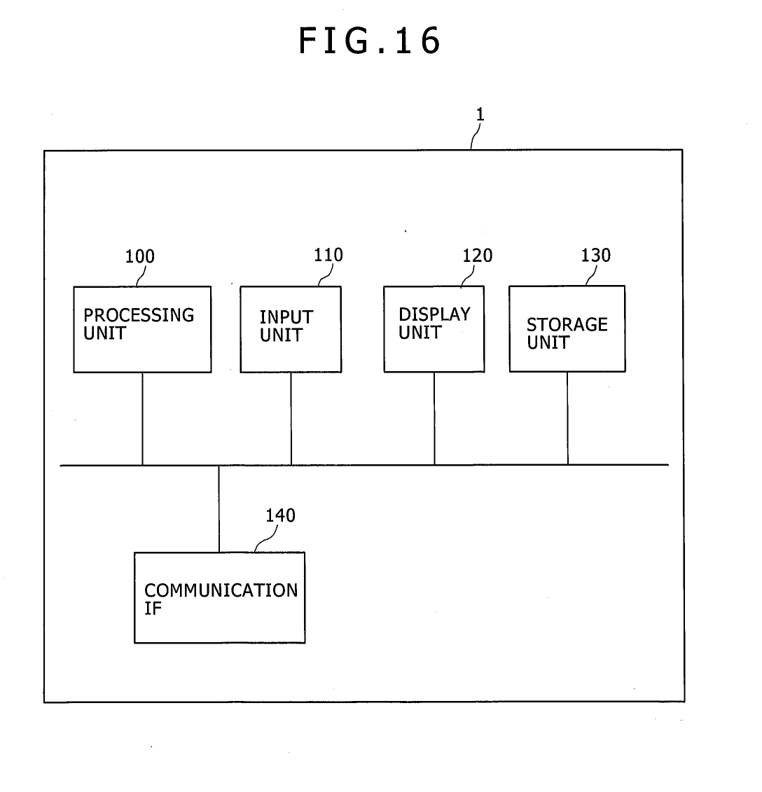

FIG. 16 is a configuration diagram of the Web server 1.

The Web server 1 includes, e.g., a processing unit 100, an input unit 110, a display unit 120, a storage unit 130, and a communication interface 140. The input unit 110 receives input of, e.g., a session ID and a user identifier. The display unit 120 displays a user identifier and SIP-URI. The storage unit 130 stores, e.g., a received session ID. The communication interface 140 is an interface for communication with, e.g., the SOAP-SIP adapter 2. The processing unit 100 executes various processes on the Web server 1.

FIG. 4-1 is a structural diagram representing an example of structure of a 3PCC service request answer information table 2600 in the terminal B5c according to the first embodiment. The 3PCC service request answer information table 2600 stores, e.g., session ID 2612, From URI 2613, answer accept/refuse information 2614, call answer terminal 2615, and reply 2616. The answer accept/refuse information 2614 indicates whether the called parity answered or refused the arrived call. In the answer accept/refuse information 2614 record, e.g., a string such as “accept” or “refuse” is stored. The call answer terminal 2615 corresponds to registration No. 2621 in an answer phone list table 2620. The reply 2616 indicates whether the terminal has replied (has sent back a SIP message) to a SIP message received. In the reply 2616 record, e.g., a string such as “not yet reply” or “replied” is stored.

FIG. 4-2 is a structural diagram representing an example of structure of the answer phone list table 2620 in the terminal B5c according to the first embodiment. The answer phone list table 2620 stores, e.g., registration No. 2621, registered terminal name 2622, and SIP-URI 2623.

### Operation

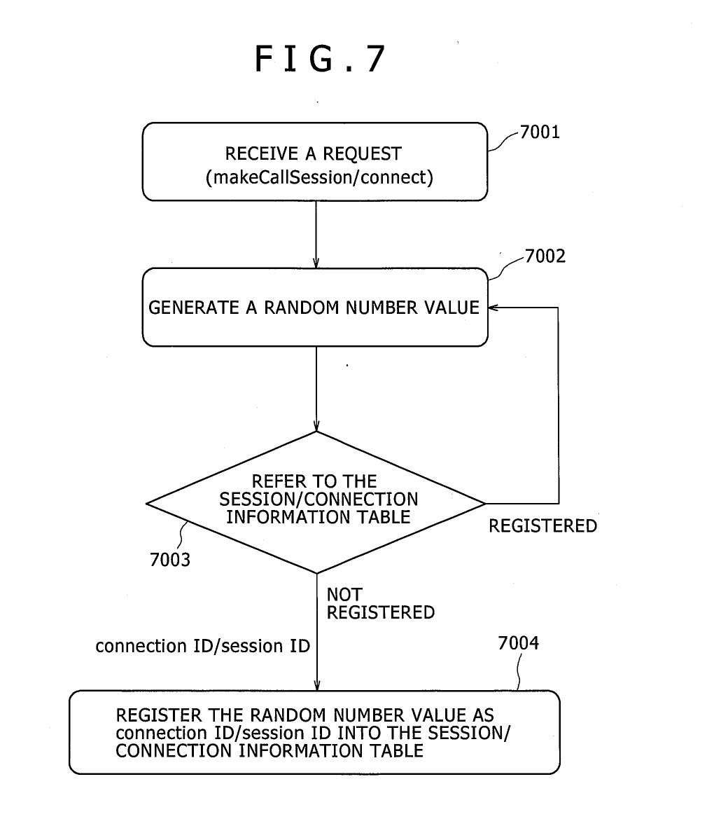

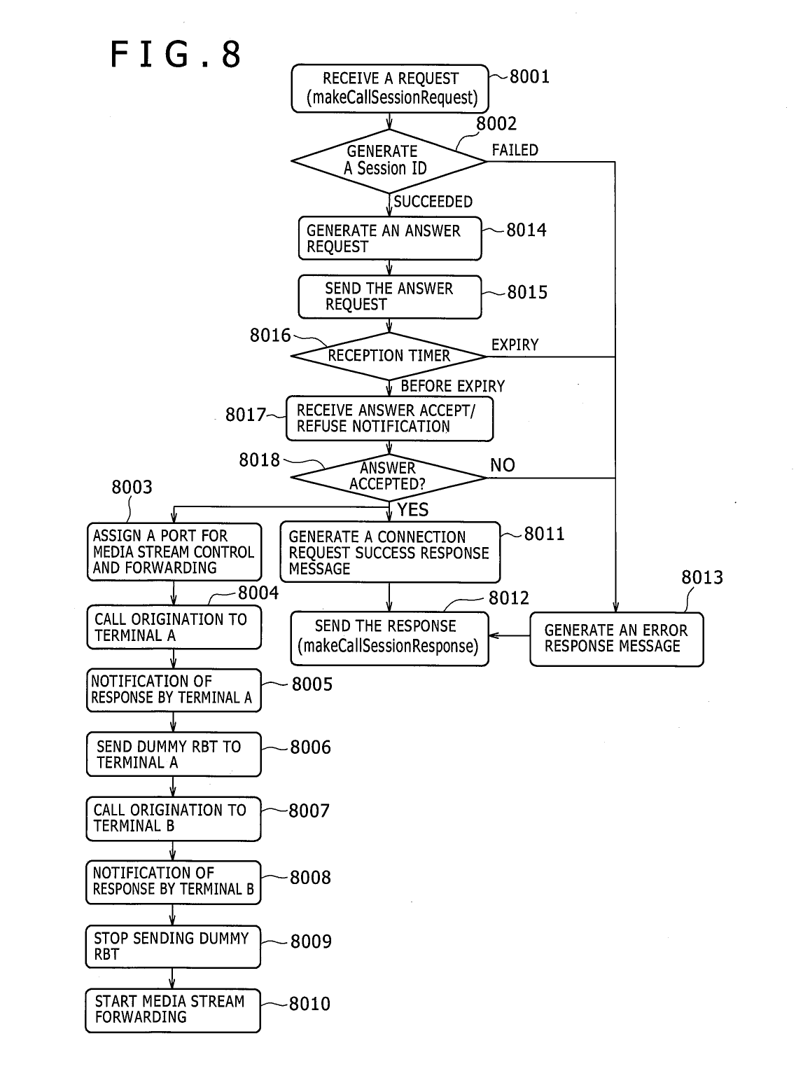

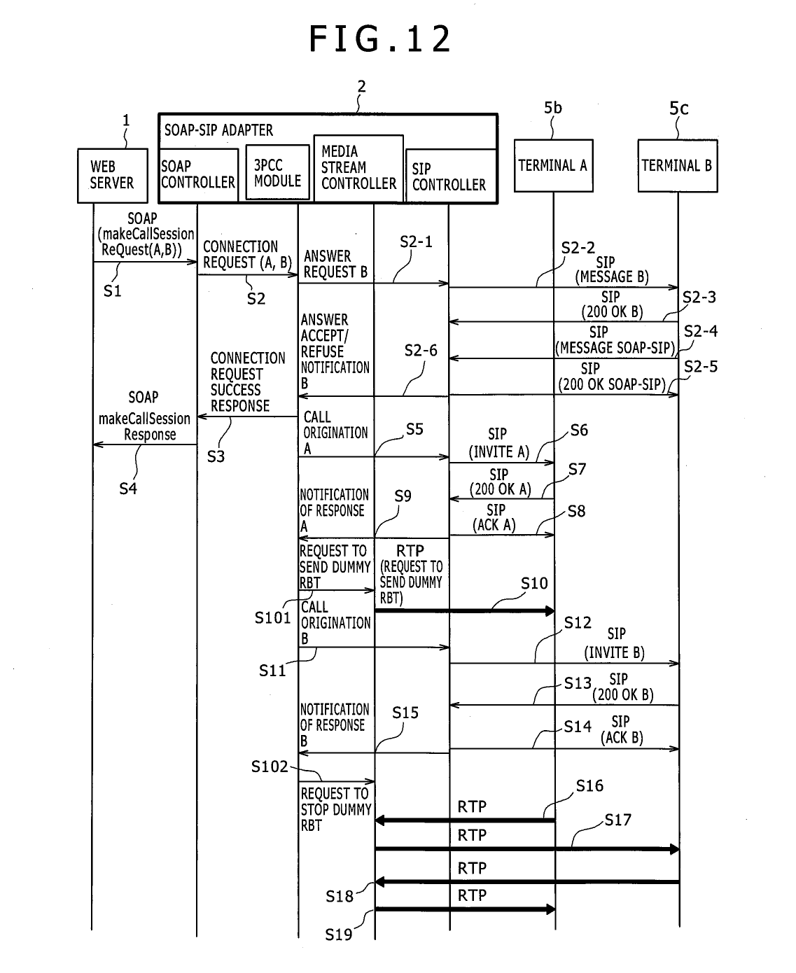

FIG. 12 is a sequence diagram to explain a 3PCC service procedure according to the first embodiment. FIG. 7 is a flowchart to explain generating a session ID/connection ID in the SOAP-SIP adapter 2. Note that connection ID is used in a second embodiment. FIG. 8 is a flowchart to explain an operation of the SOAP-SIP adapter 2 upon receiving a call initiation request according to the first embodiment.

According to the present embodiment, it becomes possible to provide a 3PCC service in a Quality of Service guaranteed NGN.

3PCC call setup is performed in the following procedure (a) to (c): (a) establishing a session between the SOAP-SIP adapter 2 and the first peer terminal A5b; (b) establishing a session between the SOAP-SIP adapter 2 and the second peer terminal B5c; and (c) setting up a call between the first peer terminal A5b and the second peer terminal B5c. However, there is a problem in which the first peer terminal A5b comes into a no-tone state in a phase after the completion of (a) and in the process of (b). So, this problem is solved by sending a dummy RBT (Ringing Back Tone as a connection keep-alive message) from the SOAP-SIP adapter 2 to the first peer terminal A5b.

In the NGN, it is a mandatory requirement that IP addresses for establishing a signaling channel and a data channel are the same. This poses a problem in which it becomes impossible that a proxy establishes a data channel between two parties (the first peer terminal A5b and the second peer terminal B5c) that are allowed to communicate with each other as in a 3PCC service flow which has heretofore been used. Therefore, in the present embodiment, the SOAP-SIP adapter 2 receives data from the first peer terminal A5b and forwards the data to the second peer terminal B5c. The SOAP-SIP adapter 2 receives data from the second peer terminal B5c and forwards the data to the first peer terminal A5b. The SOAP-SIP adapter 2 creates the media stream control information table 2040 for implementing such forwarding.

Furthermore, in the 3PCC service, because the SOAP-SIP adapter 2 which is a third party other than two parties (the first peer terminal A5b and the second peer terminal B5c) that are to communicate with each other originates a call to the two parities respectively, source information (a telephone number) that is notified to the first peer terminal A5b or the second peer terminal B5c is that information of the SOAP-SIP adapter 2, not that information of the source peer terminal (caller). Another problem is as follows: if the first peer terminal A5b makes a call, whereas a called parity (the second peer terminal B5c) cannot answer the call, although the call connection between the first peer terminal A5b and the second peer terminal B5c is not established, a session between the first peer terminal A5b and the SOAP-SIP adapter 2 is established, so the caller (the first peer terminal A5b) is charged for the established session when charging is performed at the same time. Therefore, in the first embodiment, control is implemented so that the second peer terminal B5c can identify the source peer terminal before the call is initiated between the first peer terminal A5b and the second peer terminal B5c. Unnecessary charging is avoided by asking the called party as to whether the second peer terminal B5c accepts or refuses to answer the call and by deciding whether the called party initiates or cancels a 3PCC service before establishing a session with the first peer terminal A5b. Besides, SIP messages may be exchanged between the SOAP-SIP adapter 2 and the second peer terminal B5c to allow the user of the second peer terminal B5c (the called party) to select a terminal to receive the call depending on the situation.

A procedure according to the present embodiment is described below in accordance with the sequence diagram and flowcharts.

First, a third-party user logs into the Web server 1 by operating the terminal 5a. To the Web server 1, the identifiers of users to communicate with each other (e.g., the user names of two parties corresponding to the terminal A5b and the terminal B5c) are input via the terminal 5a. For example, the user of the terminal 5a may select users as two parities to communicate with each other via a screen that the Web server 1 displayed to the terminal 5a.

The Web server 1 sends a SOAP message SOAP makeCallSessionRequest (connection request) to the SOAP-SIP adapter 2 (S1). The SOAP makeCallSessionRequest includes the SIP-URIs of the users as two parities between which a connection should be set up. For example, it is assumed that the Web server 1 has user identifiers and their SIP-URIs associatively stored in advance therein and retrieves the SIP-URIs associated with the user identifiers that have been input. The Web server 1 generates and sends the SOAP makeCallSessionRequest including the retrieved SIP-URIs to the SOAP-SIP adapter 2.

The SOAP-SIP adapter 2 sends an answer request to the terminal 5c corresponding to one of the SIP-URIs included in the received SOAP makeCallSessionRequest and receives an answer accept/refuse notification from the terminal 5c. Then, the SOAP-SIP adapter 2 starts connection setup to each terminal 5b and 5c, sends the Web server 1 a SOAP message SOAP makeCallSessionResponse including a session ID generated by the SOAP-SIP adapter 2 (S2 to S15). Detailed operation of steps S2 to S15 which take place in the SOAP-SIP adapter 2 is described below.

The SOAP controller 2101 of the SOAP-SIP adapter 2 receives the SOAP makeCallSessionRequest and sends a connection request to the 3PCC module 2102 (S2). This connection request, for example, can be generated according to an appropriate protocol which is used by the SOAP-SIP adapter 2, based on the received SOAP makeCallSessionRequest and includes the SIP-URIs specified within the SOAP makeCallSessionRequest.

Upon receiving the connection request (7001, 8001), the 3PCC module 2102 generates a session ID (8002). Referring to FIG. 7, generating a session ID is described below.

Upon receiving the connection request, the 3PCC module 2102 generates a random number value (7002). The 3PCC module 2102 decides whether or not the generated random number value has been registered in the session ID 2011 record of the session information table 2010 (7003). If the generated random number value has already been registered (that is, it has already been used), the 3PCC module 2102 returns to step 7002 and repeats a process that follows. Otherwise, if the generated random number is not registered, the 3PCC module 2102 stores the generated session ID into the session information table 2010 (7004). In addition, the 3PCC module 2102 sets the session status 2012 of the stored session ID to “Initial” in the session information table 2010.

Also, the 3PCC module 2102 stores the SIP-URIs included in the received connection request into the call participants information table 2020. In the example of the call participants information table 2020 presented in FIG. 3-2, the SIP URI of the terminal A5b (see 2020_A) and the SIP-URI of the terminal B5c (see 2020_B) are stored. The 3PCC module 2102 sets the call status 2022 to “CallParticipantlnitial” respectively in the fields of the terminals 5b, 5c of the call participants information table 2020.

Furthermore, the 3PCC module 2102 stores terminal information of the terminal A5b and the terminal B5c. Specifically, the 3PCC module 2102 stores the generated session ID into the fields of the terminals 5b, 5c of the terminal information table 2030. The 3PCC module 2102 stores each of the SIP-URIs included in the received request into the To URI 2038 record respectively in the fields of the terminals 5b, 5c of the terminal information table 2030. The 3PCC module 2102 sets the terminal status 2033 to “Initial” respectively in the fields of the terminals 5b, 5c of the terminal information table 2030. The 3PCC module 2102 sets the Role 2034 to an indicator of calling party or called parity respectively in the fields of the terminals 5b, 5c of the terminal information table 2030. A determination can be made appropriately as to which of the terminals 5b, 5c is the calling party. Also, the 3PCC module 2102 stores the IP address and the port No. of the SOAP-SIP adapter 2 into the send SDP information 2035 record in the relevant fields of the terminal information table 2030. Also, the 3PCC module 2102 stores the SIP-URI of the SOAP-SIP adapter 2 into the From URI 2037 record respectively in the fields of the terminals 5b, 5c of the terminal information table 2030. The SIP-URI, IP address, and the port No. of the SOAP-SIP adapter 2 are assumed to have been stored in advance in an appropriate storage unit.

Furthermore, the 3PCC module 2102 stores the second peer terminal answer status of the terminal BSc. Specifically, the 3PCC module 2102 stores the generated session ID into the field of the terminal 5c of the second peer terminal answer status information table 2050. Also, the 3PCC module 2102 sets the second peer terminal answer status 2052 to “Waiting” (awaiting answer) in the same field of the second peer terminal answer status information table 2050.

The 3PCC module 2102 sends the answer request (B) destined for the terminal B5c to the SIP controller 2104 (S2-1, 8014 and 8015). According to To URI included in the answer request (B), the SIP controller 2104 sends a message MESSAGE (B) to the terminal B5c (S2-2). The message MESSAGE is a method of sending an instant message in SIP. That is, it inherits a request routing function in SIP among others and includes message contents in a body part of the format. The message MESSAGE (B) includes, e.g., at least From URI, To URI, and session ID included in the received answer request.

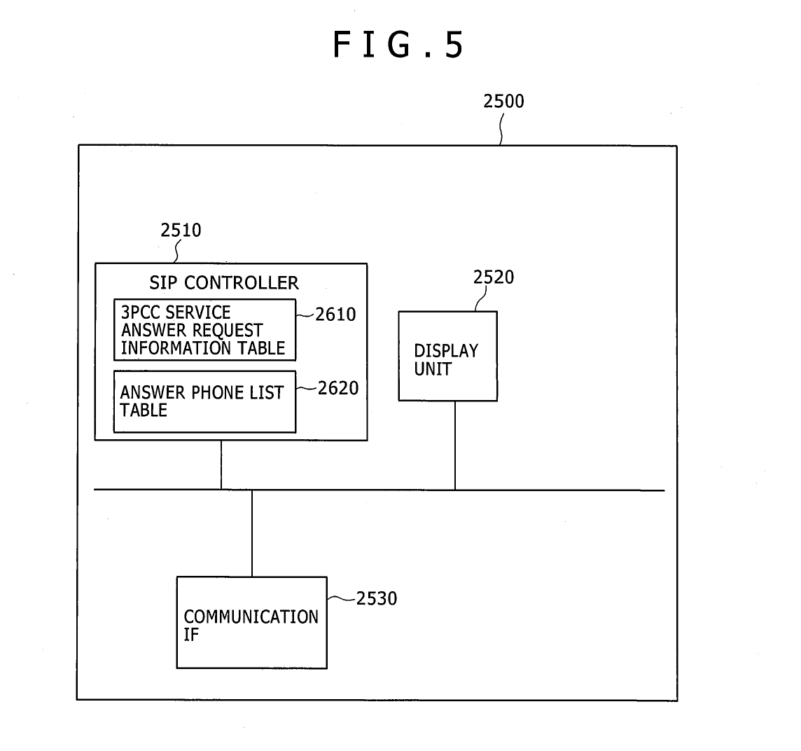

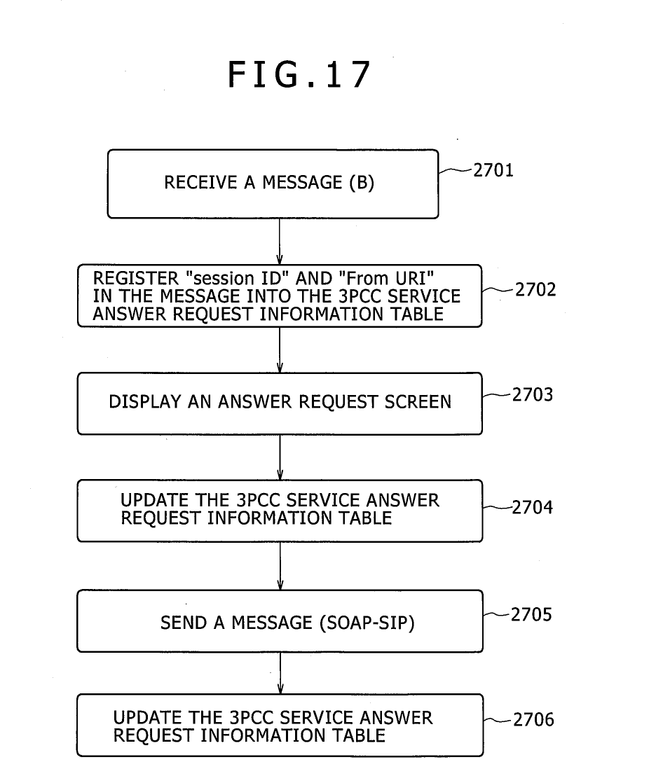

A configuration of the terminal B5c is depicted in FIG. 5. A flowchart to explain an operation of the terminal B5c particularly when receiving a SIP MESSAGE and sending a SIP MESSAGE is presented in FIG. 17. The SIP controller 2510 of the terminal B5c receives the message MESSAGE (B) (2701) and stores the session ID and From URI included in the received message MESSAGE (B) into the 3PCC service answer request information table 2610. The terminal B5c sends a SIP 200 OK (B) to the SOAP-SIP adapter 2 (S2-3). Also, the SIP controller 2510 of the terminal B5c delivers data of From URI 2613 in the field of the session ID included in the received message MESSAGE (B) from the 3PCC service answer request information table 2610 and an answer phone list table 2620 to the display unit 2520. Note that a user can register a phone into the answer phone list table 2620 in advance via a GUI screen.

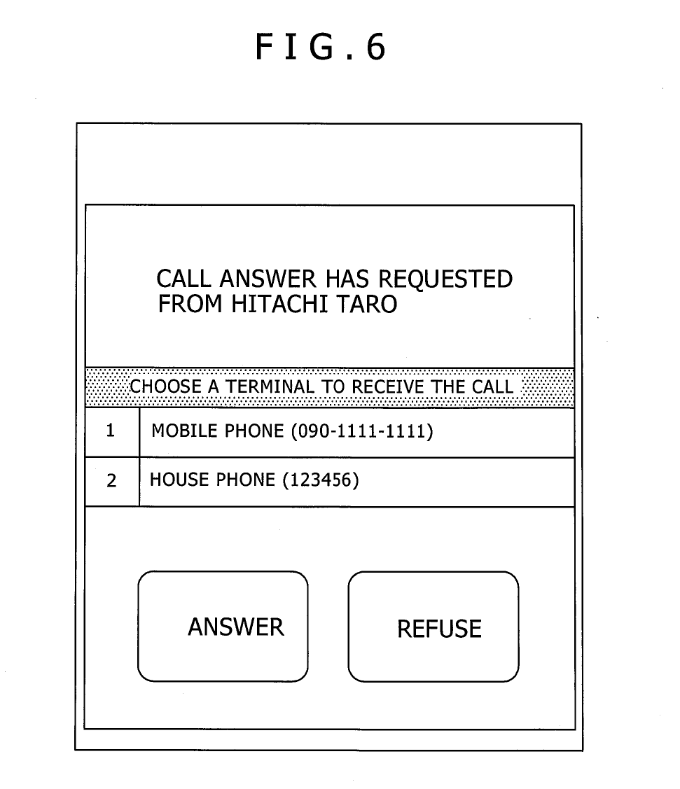

The display unit 2520 displays an answer request screen (2703, FIG. 6), based on the data of From URI 2613 and the answer phone list table 2620. It is also possible to search for a name from, e.g., a user information storing unit (phonebook) which is not depicted, based on the From URI data, and display the name. A user who operates the terminal B5c can choose a terminal to receive the call from a phone answer list and specify whether to accept or refuse to answer the call. The phone answer list displays information registered in the answer phone list table 2620. According to user input via the answer request screen, then, the SIP controller 2510 updates the data of answer accept/refuse 2614 and call answer terminal (SIP-URI of call answer terminal) 2615 in the relevant field of the 3PCC service answer request information table 2610 (2704).

Furthermore, the SIP controller 2510 of the terminal B5c sends the SOAP-SIP adapter 2 a message MESSAGE (SOAP-SIP) including the data of session ID 2612 and answer accept/refuse 2614 in the relevant field of the 3PCC service answer request information table 2610 and the data of SIP-URI of call answer terminal 2623 in the relevant field of the answer phone list table 2620 (SIP URI corresponding to call answer terminal 2615 in the 3PCC service answer request information table 2610) (S2-4). Note that the data of SIP-URI of call answer terminal 2623 is included only if the answer accept/refuse 2614 data is accept. In addition, the SIP controller 2510 of the terminal B5c updates data in the reply 2616 record from “Not yet reply” to “Replied” in the relevant field of the 3PCC service answer request information table 2610 (This data is initially defaulted to “Not yet reply”) (2706).

The SIP controller 2104 of the SOAP-SIP adapter 2 receives the message MESSAGE (SOAP-SIP) and sends a SIP 200 OK (SOAP-SIP) to the terminal B5c (S2-5).

The SIP controller 2104 sends an answer accept/refuse notification (B) to the 3PCC module 2102 (S2-6, 8017). The answer accept/refuse notification (B) includes, e.g., the data of session ID, answer accept/refuse, and SIP-URI of call answer terminal included in the MESSAGE received at step S2-4. The 3PCC module 2102 updates data in the second peer terminal answer status 2052 record to “Accept” (accept the call) and updates data in the URI of second peer terminal to answer 2053 record to the SIP-URI of call answer terminal included in the notification (B) in the relevant field of the second peer terminal answer status information table 2050. Also, the 3PCC module 2102 updates data in the URI 2021 record to the SIP-URI of call answer terminal included in the notification (B) in the field of the terminal B5c of the call participants information table 2020. Also, the 3PCC module 2102 updates data in the To URI 2038 record to the SIP-URI of call answer terminal included in the notification (B) in the relevant field of the terminal information table 2030.

The 3PCC module 2102 generates and sends a connection request success response to the SOAP controller 2101 (S3, 8011). The connection request success response includes the generated session ID. The SOAP controller 2101 receives the connection request success response and sends a SOAP makeCallSessionResponse (connection request success response) to the Web server 1 (S4, 8012). The SOAP makeCallSessionResponse includes the generated session ID and is generated, based on the received connection request success response, in accordance with SOAP. The Web server 1 receives the SOAP makeCallSessionResponse and stores the session ID included in the received SOAP makeCallSessionResponse into an appropriate storage unit.

If the 3PCC module 2102 failed to generate a session ID at step 8002, if the SOAP-SIP adapter 2 has not received a message MESSAGE (SOAP-SIP) from the terminal B5c for a given period of time at step 8016, or if the SOAP-SIP adapter 2 received the notification of answer refuse from the terminal B5c at step 8018, the 3PCC module 2102 generates and sends a connection request failure response (error response message) (8013) to the SOAP controller 2101. The SOAP controller 2101 receives the connection request failure response and sends a SOAP message SOAP makeCallSessionResponse indicating the failure of the connection request to the Web server 1 (8012). Besides, if the SOAP-SIP adapter 2 received the notification of answer refuse from the terminal B5c at step 8018, the 3PCC module 2102 updates data in the second peer terminal answer status 2052 record to “Refuse” (refuse to answer the call) in the relevant field of the second peer terminal answer status information table 2050.

Then, the SOAP-SIP adapter 2 establishes a session with the terminal A5b.

More specifically, the 3PCC module 2102 refers to the second peer terminal answer status information table 2050 and the data of second peer terminal answer status 2052 in the field of the session ID included in the answer accept/refuse notification (B) received from the SIP controller 2104 at step 8018. If the data referred to is “Waiting” (awaiting answer) or “Refuse” (refuse to answer the call), the 3PCC module 2102 terminates the process. If the data is “Accept” (accept the call), the 3PCC module 2102 continues to execute the process that follows. The 3PCC module 2102 assigns a port for media stream control and forwarding (8003). The 3PCC module 2102 sends to the SIP controller 2104 a request for call origination (A) to the terminal A5b (S5, 8004). For example, the 3PCC module 2102 sends the request for call origination including the data of send SDP information 2035, From URI 2037, and To URI 2038 stored in the field of the terminal A5b of the terminal information table 2030 to the SIP controller 2104. By way of example, the 3PCC module 2102 stores a timestamp denoting the time instant at this time into a cell of the starting time 2023 record in the field of the terminal A5b of the call participants information table 2020. In the example of the call participants information table 2020 presented in FIG. 3-2, a timestamp “2008.10.22 10:30.30” is stored. Note that the starting time 2023 is not limited to the time instant at this time and an appropriate timestamp denoting the start of the session with the terminal A5b may be stored.

According to the To URI data included in the request for call origination (A), the SIP controller 2104 sends an INVITE message (A) to the terminal A5b (S6). The INVITE message (A) includes, e.g., at least the data of send SDP information, From URI, and To URI included in the received request for call origination. Also, the SIP controller 2104 generates a handle value identifying the session with the terminal A5b.

The terminal A5b receives the INVITE message (A) and stores the IP address and port No. of the SOAP-SIP adapter 2 included in the send SDP information in the received INVITE message (A) into an appropriate storage unit. The stored IP address and port No. are used, e.g., when the terminal transmits media streams. The terminal A5b generates recv SDP information including its IP address and port No. and sends a SIP 200 OK (A) including the generated SDP information to the SOAP-SIP adapter 2 (S7). The SIP controller 2104 of the SOAP-SIP adapter 2 receives the SIP 200 OK (A) and sends SIP ACK (A) to the terminal A5b (S8).

The SIP controller 2104 sends a notification of response (A) to the 3PCC module 2102 (S9, 8005). The notification of response (A) includes, e.g., the handle value generated at step S6 and the recv SDP information of the terminal A5b included in the 200 OK received at step S7. The 3PCC module 2102 stores the handle value and recv SDP information included in the received notification of response (A) into the field of the terminal A5b of the terminal information table 2030. Note that the handle value may be stored at appropriate timing in the course of steps S6 to S8. The 3PCC module 2102 updates data of terminal status 2033 to “CallComplete” (having established the session) in the field of the terminal A5b of the terminal information table 2030. Also, the 3PCC module 2102 updates data of call status 2022 to “CallParticipantConnected” in the field of the terminal A5b of the call participants information table 2020. Note that the terminal status 2033 data may be updated appropriately in response to sending/receiving a SIP message (such as, e.g., 200 OK).

Also, the 3PCC module 2102 sends the generated session ID, the IP address and port No. of the SOAP-SIP adapter 2, and the IP address and port No. of the terminal A5b which are included in the recv SDP information it received to the media stream controller 2103. The media stream controller 2103 stores the received information respectively into the media stream control information table 2040. For example, the media stream controller 2103 stores the received IP address and port No. of the SOAP-SIP adapter 2 into the corresponding cells of the IP address for sending/receiving media streams 2042 record and the port No. for sending/receiving media streams 2043 record and stores the received IP address and port No. of the terminal A5b into the corresponding cells of the correspondent IP address (1) 2044 record and the correspondent port No. (1) 2045 record. Also, the media stream controller 2103 stores the received session ID.

The 3PCC module 2102 sends a request to send dummy RBT to the media stream controller 2103 (S101). Upon receiving the request to send dummy RBT, the media stream controller 2103 sends dummy RBT to the terminal A5b in accordance with, e.g., a Real-time Transport Protocol (RTP) (S10, 8006). The media stream controller 2103 may use, e.g., an announcement that the called party is being called, appropriate music, etc. as the dummy RBT. In the present embodiment, the dummy RBT sending prevents the terminal A5b from coming into a no-tone state in a phase after the establishment of the session with the terminal A5b and in the process of establishing a session with the terminal B5c. The media stream controller 2103 can continue to send this dummy RBT until receiving a request to stop dummy RBT which will be described later.

Then, the SOAP-SIP adapter 2 establishes a session with the terminal B5c.

The 3PCC module 2102 sends to the SIP controller 2104 a request for call origination (B) to the terminal B5c (S11, 8007). For example, the 3PCC module 2102 sends the request for call origination including the data of send SDP information 2035, From URI 2037, and To URI 2038 stored in the field of the terminal B5c of the terminal information table 2030 to the SIP controller 2104. Also, the 3PCC module 2102 stores a timestamp denoting the time instant at this time into a cell of the starting time 2023 record in the field of the terminal B5c of the call participants information table 2020. In the example of the call participants information table 2020 presented in FIG. 3-2, a timestamp “2008.10.22 10:30.45” is stored.

According to the To URI data included in the request for call origination (B), the SIP controller 2104 sends an INVITE message (B) to the terminal B5c (S12). The INVITE message (B) includes, e.g., at least the data of send SDP information, From URI, and To URI included in the received request for call origination and uses the updated SIP-URI of call answer terminal. Also, the SIP controller 2104 generates a handle value identifying the session with the terminal B5c.

The terminal B5c receives the INVITE message (B) and stores the IP address and port No. of the SOAP-SIP adapter 2 included in the send SDP information in the received INVITE message (B) into an appropriate storage unit. Also, the terminal B5c generates recv SDP information including its IP address and port No. and sends a 200 OK (B) including the generated recv SDP information to the SOAP-SIP adapter 2 (S13). The SIP controller 2104 of the SOAP-SIP adapter 2 receives the 200 OK (B) and sends ACK (B) to the terminal B5c (S14).

The SIP controller 2104 sends a notification of response (B) to the 3PCC module 2102 (S15, 8008). The notification of response (B) includes, e.g., the handle value generated at step S12 and the recv SDP information of the terminal B5c included in the 200 OK received at step S13. The 3PCC module 2102 stores the handle value and recv SDP information included in the received notification of response (B) into the field of the terminal B5c of the terminal information table 2030. Note that the handle value may be stored at appropriate timing in the course of steps S12 to S14. The 3PCC module 2102 updates data of terminal status 2033 to “CallComplete” (having established the session) in the field of the terminal B5c of the terminal information table 2030. Also, the SPCC module 2102 updates data of call status 2022 to “CallParticipantConnected” in the field of the terminal B5c of the call participants information table 2020. Also, the 3PCC module 2102 updates data of session status to “Connected” in the relevant field of the session information table 2010.

The 3PCC module 2102 sends the session ID and the IP address and port No. of the terminal B5c included in the recv SDP information it received to the media stream controller 2103. The media stream controller 2103 stores the IP address and port No. of the terminal B5c into the corresponding cells of the correspondent IP address (2) 2046 record and the correspondent port No. (2) 2047 record in the field of the received session ID of the media stream control information table 2040.

The 3PCC module 2102 sends a request to stop dummy RBT to the media stream controller 2103 (S102, 8009). According to the request to stop dummy RBT, the media stream controller 2103 stops sending dummy RBT.

The SOAP-SIP adapter 2 starts media stream forwarding between the terminal A5b and the terminal B5c (8010).

For example, the terminal A5b transmits media streams to the SOAP-SIP adapter 2 in accordance with RTP (S16). In this transmission, the terminal A5b sets, as the destination, the IP address and port No. of the SOAP-SIP adapter 2 stored at step S6 and sets, as the source, its IP address and port No.

The media stream controller 2103 of the SOAP-SIP adapter 2 refers to the media stream control information table 2040 and forwards the received media streams to the terminal B5c (S17). For example, the media stream controller 2103 refers to the media stream control information table 2040, based on the source IP address and port No. of the received media streams, and retrieves the correspondent IP address and port No. paired with the source IP address and port No. In the example of the media stream control information table 2040 presented in FIG. 3-4, the source IP address and port No. of the received media streams are the IP address (10.0.2.1) and port No. (20000) of the terminal A5b and the correspondent IP address (2) 2046 (10.0.2.2) and port No. (2) 2047 (30000) paired with those of the terminal A5b are retrieved. According to the IP address and port No. thus retrieved, the media stream controller 2103 forwards the received media streams to the terminal B5c.

Likewise, the terminal B5c transmits media streams to the SOAP-SIP adapter 2 in accordance with RTP (S18). As is the case for the terminal A5b, the terminal B5c sets, as the destination, the IP address and port No. of the SOAP-SIP adapter 2 stored at step S12 and sets, as the source, its IP address and port No.

The media stream controller 2103 of the SOAP-SIP adapter 2 refers to the media stream control information table 2040 and forwards the received media streams to the terminal A5b (S19). In the example of the media stream control information table 2040 presented in FIG. 3-4, the source IP address and port No. of the received media streams are the IP address (10.0.2.2) and port No. (30000) of the terminal B5c and the correspondent IP address (1) 2044 (10.0.2.1) and port No. (1) 2045 (20000) paired with those of the terminal B5c are retrieved. According to the IP address and port No. thus retrieved, the media stream controller 2103 forwards the received media streams to the terminal A5b.

In the way as described above, the IP addresses for establishing a signaling channel are the same as the IP addresses for establishing a data channel and a SPCC service in a Quality of Service guaranteed NGN can be implemented this way: the SOAP-SIP adapter 2 receives data from the terminal A5b and forwards the data to the terminal B5c and also receives data from the terminal B5c and forwards the data to the terminal A5b.

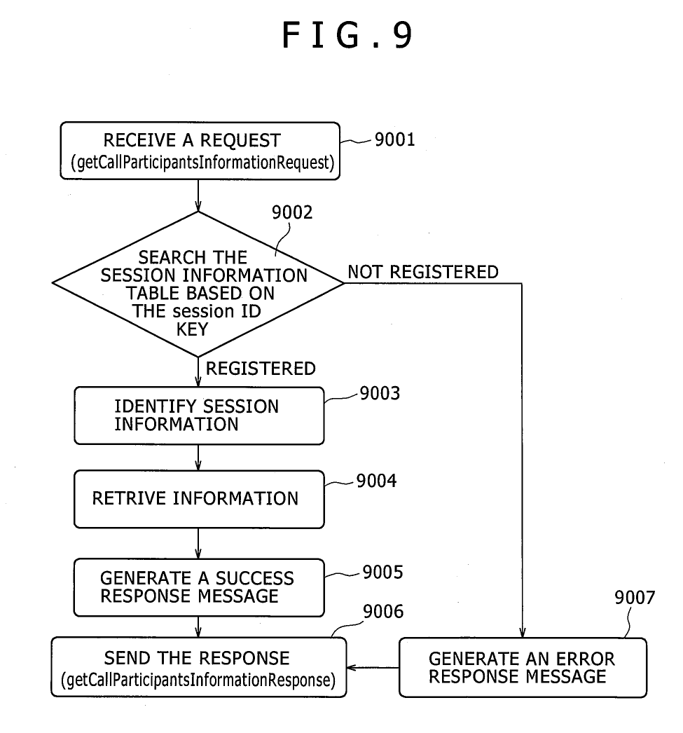

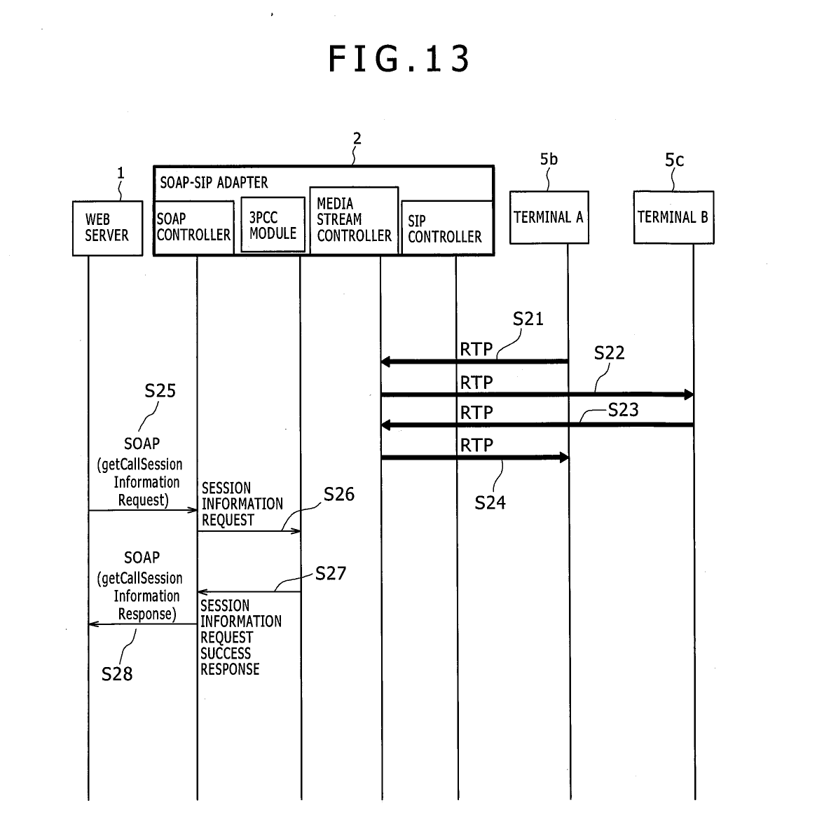

FIG. 13 is a sequence diagram (2) to explain a 3PCC service procedure according to the first embodiment. FIG. 9 is a flowchart to explain an operation of the SOAP-SIP adapter 2 upon receiving a call information (session information) request according to the first embodiment.

Referring to FIGS. 13 and 9, an operation in which the Web server 1 gets call information is described. Here, it is assumed that the Web server 1 can get information associated with a specified session ID. A process of steps S21 to S24 in FIG. 13 corresponds to a process of steps S16 to S19 described previously.

The Web server 1 sends a SOAP getCallSessionInformationRequest (session information request, call information request) to the SOAP-SIP adapter 2 (S25). The SOAP getCallSessionInformationRequest includes a session ID for which the Web server 1 wants to get call information. More specifically, the Web server 1 generates and sends a SOAP getCallSessionInformationRequest including a session ID stored at the foregoing step S4 to the SOAP-SIP adapter 2. Note that the Web server 1 may select a session ID for which it wants to get call information out of session IDs stored at the foregoing step S4, based on user input via the terminal 5a.

The SOAP-SIP adapter 2 searches the session information table 2010 held in it, based on the session ID as a search key, which is included in the SOAP getCallSessionInformationRequest, and sends a SOAP getCallSessionInformationResponse including table information retrieved from the matched session ID 2011 field (S26 to S28). Detailed operation of steps S26 to S28 which take place in the SOAP-SIP adapter 2 is described below.

First, the SOAP controller 2101 of the SOAP-STP adapter receives the SOAP getCallSessionInformationRequest and sends a session information request to the 3PCC module 2102 (S26). This session information request includes the session ID within the SOAP getCallSessionInformationRequest.

Upon receiving the session information request (9001), the 3PCC module 2102 searches the session ID 2011 record within the session information table 2010, based on the session ID included in the received session information request (9002). If the session ID included in the received session information request has been registered in the session information table 2010, session information in the field of the matched session ID 2011 is identified (9003). The 3PCC module 2102 refers to the call participants information table (call participants status) 2020 linked in the field of the matched session ID 2011 and retrieves, e.g., URIs and call status data from the URI 2021 and call status 2022 records respectively in the fields of the terminals 5b, 5c (9004). In addition, the 3PCC module 2102 retrieves, e.g., recv SDP information 2036 of each terminal respectively from the terminal information (for Client A) 2030_A and the terminal information (for Client B) 2030_B liked in the field of the matched session ID 2011.

The 3PCC module 2102 generates a session information request success response including the session ID 2011 and the URIs 2021, call status 2022, and recv SDP information 2036 thus retrieved (9005) and sends the generated session information request success response to the SOAP controller 2101 (S27). The SOAP controller 2101 receives the session information request success response and sends a SOAP getCallSessionInformationResponse (session information request success response) to the Web server 1 (S28, 9006). The SOAP getCallSessionInformationResponse includes the session ID, URIs, call status data, and recv SDP information within the received session information request success response and is generated in accordance with SOAP.

If the session ID included in the received session information request is not registered at step 9002, the 3PCC module 2102 generates a session information request failure response (error response message) (9007) and sends the generated session information request failure response to the SOAP controller 2101. The SOAP controller 2101 receives the session information request failure response and sends a SOAP getCallSessionInformationResponse indicating the failure of the session information request to the Web server 1 (9006).

The Web server 1 receives the SOAP getCallSessionInformationResponse and can ascertain the session status such as whether the requested communication has been established by referring to, e.g., the call status data included in the received SOAP getCallSessionInformationResponse. If a terminal has terminated a call, then the call status data “CallParticipantTerminated” is included in the response and the Web server 1 can judge that the terminal A5b or terminal B5c has terminated the call. Besides, for example, if the call status data indicates abnormality, the Web server 1 may stop the communication, e.g., using a SOAP endCallSessionRequest which will be described later.

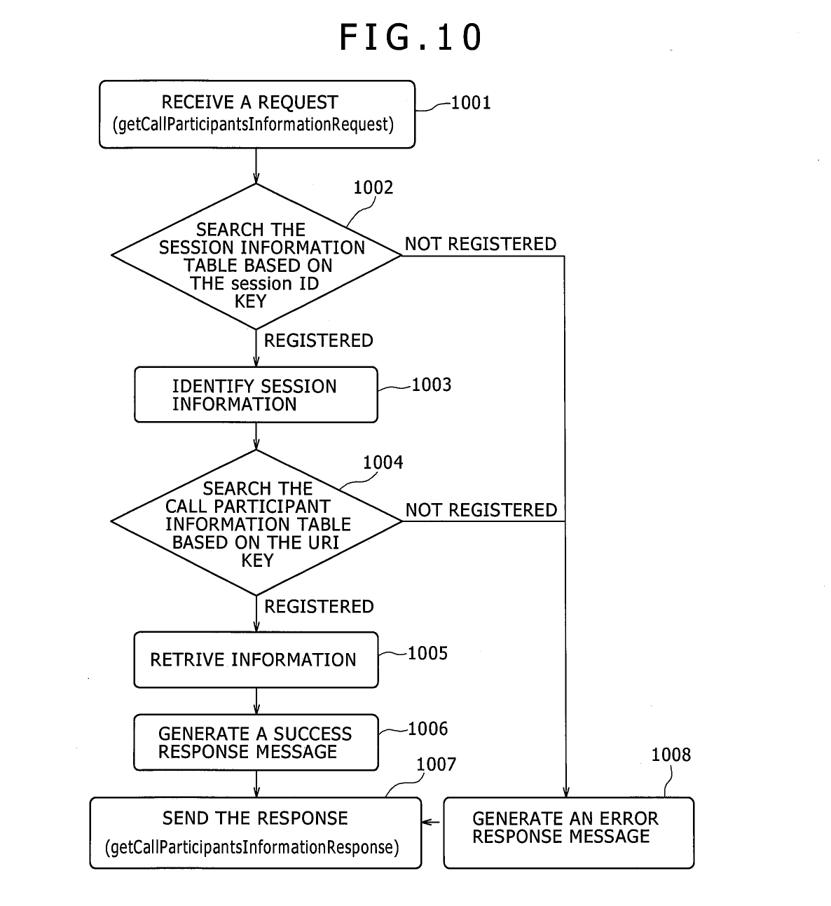

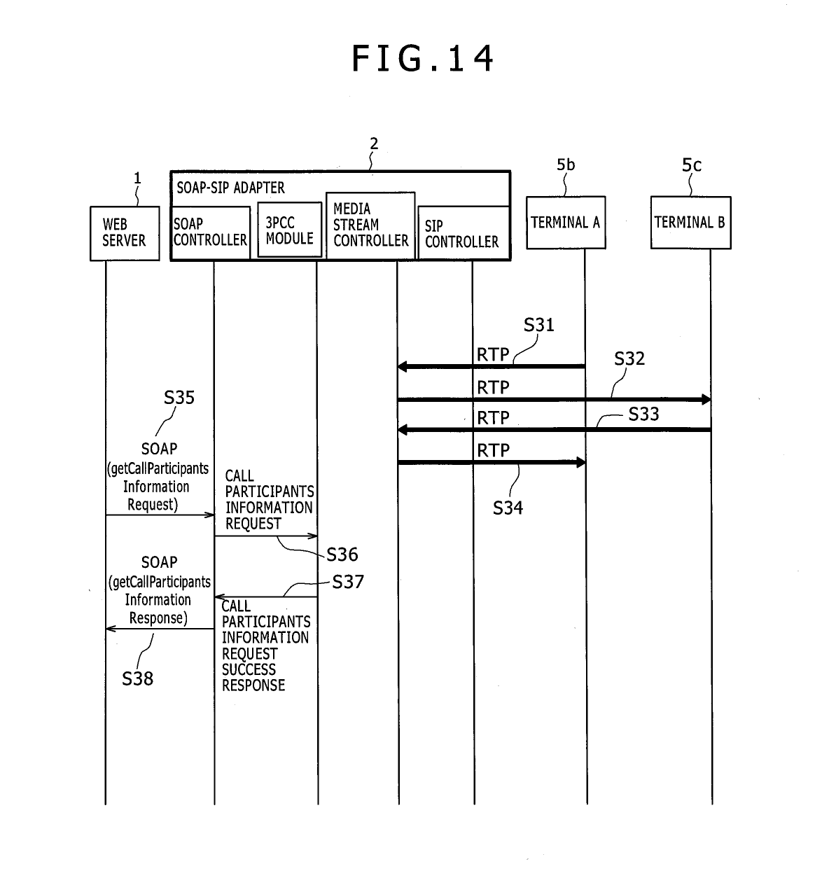

FIG. 14 is a sequence diagram (3) to explain a 3PCC service procedure according to the first embodiment. FIG. 10 is a flowchart to explain an operation of the SOAP-SIP adapter 2 upon receiving a call participants information request according to the first embodiment.

Referring to FIGS. 14 and 10, an operation in which the Web server 1 gets call participants information is described. Here, it is assumed that the Web server 1 can get user information associated with specified SIP-URIs. A process of steps S31 to S34 in FIG. 14 corresponds to a process of steps S16 to S19 described previously.

The Web server 1 sends a SOAP getCallParticipantsInformationRequest (call participants information request) to the SOAP-SIP adapter 2 (S35). The SOAP getCallParticipantsInformationRequest includes a session ID and URIs for which the Web server 1 wants to get call participants information. Specifically, the Web server 1 generates and sends a SOAP getCallParticipantsInformationRequest including a session ID stored at the foregoing step S4 and the SIP-URIs of desired call participants to the SOAP-SIP adapter 2. By way of example, the Web server 1 may select a session ID and user identifiers (e.g., user names corresponding to the terminal A5b and terminal B5c) for which it wants to get call participants information, based on user input via the terminal 5a. The Web server 1 has user identifiers and their SIP-URIs associatively stored in advance therein, as described previously, so that it can get SIP-URIs associated user identifiers which have been input.

The SOAP-SIP adapter 2 searches the session information table 2010 held in it, based on the session ID as a search key, which is included in the SOAP getCallParticipantsInformationRequest, and identifies table information in the matched session ID 2011 field. In addition, the SOAP-SIP adapter 2 searches the call participants information table 2020, based on the SIP-URIs as search keys, which are included in the getCallParticipantsInformationRequest, and sends a SOAP getCallParticipantsInformationResponse including table information retrieved from the fields of the matched SIP-URIs 2021 (S36 to S38). Detailed operation of steps S36 to S38 which take place in the SOAP-SIP adapter 2 is described below.

The SOAP controller 2101 of the SOAP-SIP adapter 2 receives the SOAP getCallParticipantsInformationRequest and sends a call participants information request to the 3PCC module 2102 (S36). This call participants information request includes the session ID and SIP-URIs within the SOAP getCallParticipantsInformationRequest. Upon receiving the call participants information request (1001), the 3PCC module 2102 searches the session ID 2011 record within the session information table 2010, based on the session ID included in the received call participants information request (1002). If the session ID included in the received call participants information request has been registered in the session information table 2010, session information in the field of the matched session ID 2011 is identified (1003). The 3PCC module 2102 searches the URI 2021 record within the call participants information table (call participants status) 2020 linked in the field of the matched session ID 2011, based on the SIP-URIs included in the received call participants information request (1004). If the SIP-URIs included in the received call participants information request have been registered, the 3PCC module 2102 retrieves call status data from the call status 2022 record in the fields of the matched URIs 2021 (1005). Also, the 3PCC module 2102 refers to the To URI 2038 record within the terminal information table 2030, based on the SIP-URIs included in the received call participants information request, and retrieves recv SDP information 2036 in the relevant fields.

The 3PCC module 2102 generates a call participants information request success response including the URIs 2021 and the call status 2022 and recv SDP information 2036 thus retrieved (1006) and sends the generated call participants information request success response to the SOAP controller 2101 (S37). The SOAP controller 2101 receives the call participants information request success response and sends a SOAP getCallParticipantsInformationResponse (call participants information request success response) to the Web server 1 (S38, 1007). The SOAP getCallParticipantsInformationResponse includes the URIs, call status, and recv SDP information within the received call participants information request success response and is generated in accordance with SOAP.

If the session ID included in the received call participants information request is not registered at step 1002 and if the SIP-URIs included in the received call participants information request is not registered at step 1004, the 3PCC module 2102 generates a call participants information request failure response (error response message) (1008) and sends the generated call participants information request failure response to the SOAP controller 2101. The SOAP controller 2101 receives the call participants information request failure response and sends a SOAP getCallParticipantsInformationResponse indicating the failure of the call participants information request to the Web server 1 (1007).

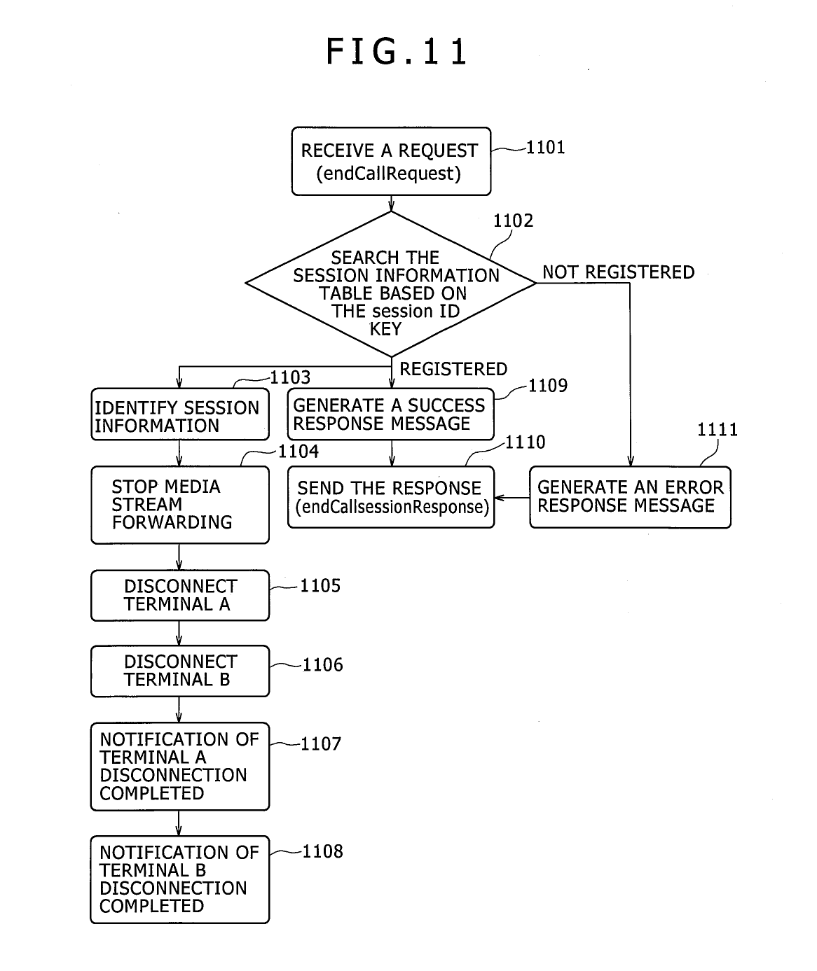

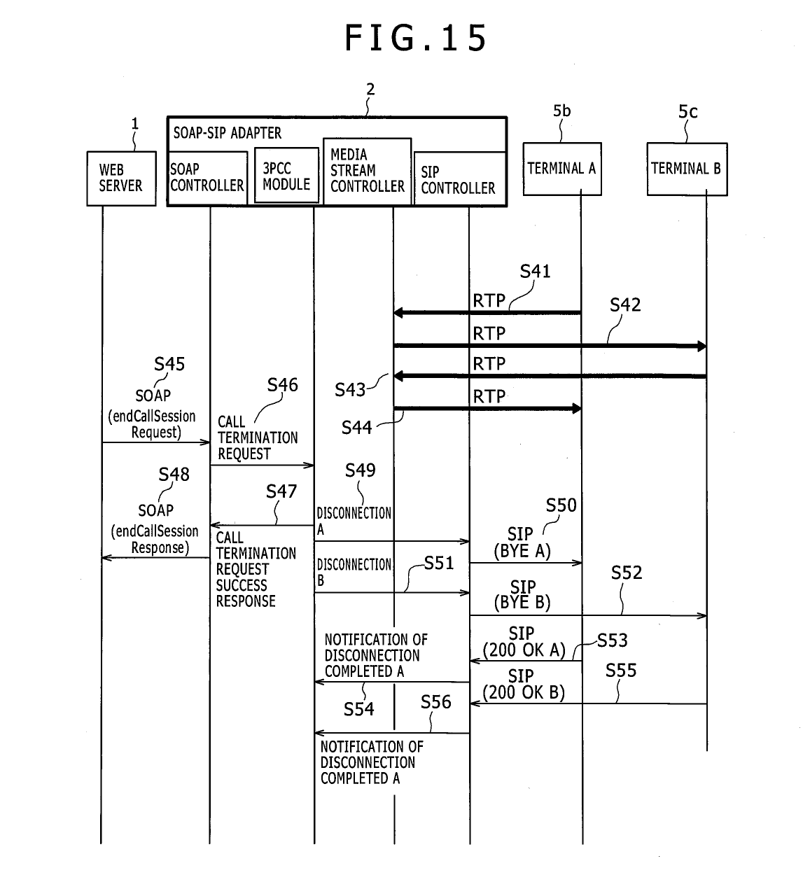

FIG. 15 is a sequence diagram (4) to explain a 3PCC service procedure according to the first embodiment. FIG. 11 is a flowchart to explain an operation of the SOAP-SIP adapter 2 upon receiving a call termination request according to the first embodiment.

FIGS. 15 and 11 explain an operation in which the Web server 1 terminates a call. A process of steps S41 to S44 in FIG. 15 corresponds to a process of steps S16 to S19 described previously.

The Web server 1 sends a SOAP endCallSessionRequest (call termination request) to the SOAP-SIP adapter 2 (S45). The SOAP endCallSessionRequest includes the session ID of a call that the Web server 1 wants to terminate. More specifically, the Web server 1 generates and sends a SOAP endCallSessionRequest including a session ID stored at the foregoing step S4 to the SOAP-SIP adapter 2. By way of example, the Web server 1 may select the session ID of a call that it wants to terminate out of session IDs stored at the foregoing step S4, based on user input via the terminal 5a.

The SOAP-SIP adapter 2 searches the session information table 2010 held in it, based on the session ID as a search key, which is included in the SOAP endCallSessionRequest, identifies terminals 5b, 5c to be disconnected from table information in the field of the matched session ID 2011, and disconnects them (S46 to S56). Detailed operation of steps S46 to S56 which take place in the SOAP-SIP adapter 2 is described below.

The SOAP controller 2101 of the SOAP-SIP adapter 2 receives the SOAP endCallSessionRequest (call termination request) and sends a call termination request to the 3PCC module 2102 (S46). This call termination request includes the session ID within the SOAP endCallSessionRequest. Upon receiving the call termination request (1101), the 3PCC module 2102 searches the session ID 2011 record within the session information table 2010, based on the session ID included in the received call termination request (1102).

If the session ID included in the received call termination request has been registered in the session information table 2010, the SPCC module 2102 generates a call termination request success response (1109) and sends the generated call termination request success response to the SOAP controller 2101 (S47). The SOAP controller 2101 receives the call termination request success response and sends a SOAP endCallSessionResponse (call termination request success response) to the Web server 1 (S48, 1110). Note that a SOAP endCallSessionResponse indicating a success response may only be sent.

Also, the 3PCC module 2102 identifies session information in the field of the matched session ID 2011 and identifies two parties (terminal A5b and terminal B5c in this example) participating the call session (1103). For example, the 3PCC module 2102 refers to the call participants information table 2020 linked in the field of the session ID included in the received call termination request and retrieves the SIP-URIs of the terminals A5b and B5c from the SIP-URI 2021 record. The media stream controller 2103 stops media stream forwarding (1104). The 3PCC module 2102 may send a request to stop media stream forwarding to the media stream controller 2103.

According to one of the SIP-URIs retrieved, the 3PCC module 2102 sends a disconnection request (A) including the retrieved SIP-URI to the SIP controller 2104 (S49, 1105). The SIP controller 2104 receives the disconnection request (A) and sends a SIP BYE message (A) in which the SIP-URI included in the received disconnection request (A) is set as “To URI” to the terminal A5b (S50).

Likewise, according to the other one of the SIP-URIs retrieved, the 3PCC module 2102 sends a disconnection request (B) including the retrieved SIP-URI to the SIP controller 2104 (S51, 1106). The SIP controller 2104 receives the disconnection request (B) and sends a BYE message (B) in which the SIP-URI included in the received disconnection request (B) is set as “To URI” to the terminal B5c (S52).

The terminal A5b sends a 200 OK (A) in response to the BYE message (A) received at step S50 to the SOAP-SIP adapter 2 (S53). The SIP controller 2104 of the SOAP-SIP adapter 2 receives the 200 OK (A) and sends a notification of disconnection completed (A) to the 3PCC module 2102 (S54, 1107).

Likewise, the terminal B5c sends a 200 OK (B) in response the BYE message (B) received at step S52 to the SOAP-SIP adapter 2 (S55). The SIP controller 2104 of the SOAP-SIP adapter 2 receives the 200 OK (B) and sends a notification of disconnection completed (B) to the 3PCC module 2102 (S56, 1108).

If the session ID included in the received call termination request is not registered at step 1102, the 3PCC module 2102 generates a call termination request failure response (error response message) (1111) and sends the generated call termination request failure response to the SOAP controller 2101. The SOAP controller 2101 receives the call termination request failure response and sends a SOAP endCallSessionResponse indicating the failure of the call termination request to the Web server 1 (1110).

1. A communication system comprising a Web server and a control apparatus that communicates with a first terminal and a second terminal,
wherein the control apparatus includes:
an interface that receives from the Web server a call setup request message including “To URI” corresponding to the first terminal and “From URI” corresponding to the second terminal; and
a first controller that sends a first message including the “To URI”, the “From URI”, and a session ID to the first terminal in accordance with the received call setup request message, performs control so that a call setup response message is sent to the Web server, if the control apparatus receives from the first terminal a second message including the session ID and information indicating answer accept in response to the first message, and sets up a first session with the first terminal based on the session ID as well as a second session with the second terminal based on the session ID.

2. The communication system according to claim 1, wherein the call setup request message and the call setup response message are SOAP messages and the first message and the second message are SIP MESSAGE messages.

3. The communication system according to claim 1, wherein the second message includes the SIP URI of the first terminal as the SIP URI of a call answer terminal.

4. The communication system according to claim 1, wherein the control apparatus further comprises a first table that associatively stores the session ID, answer status information of a called party terminal, and identification information of the called parity terminal for a call requested by the call setup request message; and, when receiving the second message, updates the answer status information of the called party terminal based on the information indicating answer accept in response to the first message and updates the identification information of the called parity terminal to the SIP URI of the call answer terminal.

5. The communication system according to claim 1, wherein the control apparatus further comprises a second table storing the SIP URIs and status information of the first terminal and the second terminal and a third table storing at least identification information of and “To URI” and “From URI” of the first session and the second session; and, when receiving the second message, updates the SIP URI of the first terminal in the second table and the “To URI” in the third table to the SIP URI of the call answer terminal.

6. The communication system according to claim 1,
wherein the control apparatus further includes a second controller,
wherein the first controller, when receiving the second message, sends a notification of answer accept to the second controller, and
wherein the second controller, when receiving the notification of answer accept, sends to the first controller a request for call origination to the first terminal and a request for call origination to the second terminal.

7. The communication system according to claim 1, wherein the second controller, when receiving the notification of answer accept, initiates 3rd Party Call Control for the first terminal and the second terminal.

8. The communication system according to claim 1, wherein, after setting up the first session and the second session, the control apparatus forwards media streams transmitted by one of the first terminal and the second terminal to the other one of the first terminal and the second terminal.

9. The communication system according to claim 1, wherein the first controller performs control so that a connection request failure message is sent to the Web server, if the second message from the first terminal includes information indicating refuse to answer in response to the first message, not information indicating answer accept in response to the first message.

10. A communication method comprising:
receiving by a control apparatus a call setup request message including “To URI” corresponding to a first terminal and “From URI” corresponding to a second terminal from a Web server;
sending by the control apparatus a first message including the “To URI”, the “From URI”, and a session ID to the first terminal in accordance with the received call setup request message;
displaying information on a call source corresponding to the “From URI” and an input window for specifying whether to accept or refuse an answer to the call source on a display unit of the first terminal;
if the first terminal receives an input accepting an answer to the call source, receiving by the control apparatus a second message including the session ID and information indicating answer accept in response to the first message from the first terminal;
after receiving the second message, sending by the control apparatus a call setup response message to the Web server; and
setting up by the control apparatus a first session with the first terminal based on the session ID as well as a second session with the second terminal based on the session ID.
